(19) United States
(12) Patent Application Publication
(10) Pub. No.: US 2025/0308094 A1
(43) Pub. Date: Oct. 2, 2025

(54) PRODUCING DATA OUTPUT SYSTEM

(71) Applicant: BROTHER KOGYO KABUSHIKI KAISHA, Nagoya (JP)

(72) Inventors: Yuta KAMIHIRA, Yokkaichi (JP); Mayumi NISHIZAKI, Nagoya (JP)

(73) Assignee: BROTHER KOGYO KABUSHIKI KAISHA, Nagoya (JP)

(21) Appl. No.: 19/091,120

(22) Filed: Mar. 26, 2025

(30) Foreign Application Priority Data
Mar. 29, 2024 (JP) 2024-055912

(51) Int. Cl. G06T 11/00; B26D 5/00; B41J 3/46; D05B 19/02; G06K 15/02

(52) U.S. Cl. CPC G06T 11/001; B26D 5/00; B41J 3/46; D05B 19/02; G06K 15/1848; G06T 2200/24

(57) ABSTRACT

A controller of a producing data output system acquires a target image. The controller performs style conversion on the target image to generate a converted image of a selected style. The selected style is selected from image styles including first and second styles. The controller outputs producing data for producing a medium based on the converted image. The selected producing type is selected from one or more producing candidates associated with the selected style. The one or more producing candidates are among producing types including first and second producing types. In a case where the selected style is the first style, the one or more producing candidates include the first producing type and do not include the second producing type. In a case where the selected style is the second style, the one or more producing candidates include the first and second producing types.

### REFERENCE TO RELATED APPLICATIONS

This application claims priority from Japanese Patent Application No. 2024-055912 filed on Mar. 29, 2024. The entire content of the priority application is incorporated herein by reference.

### BACKGROUND ART

An image style conversion apparatus that converts a style of an image by using a neural network is known.

### SUMMARY

An image style conversion apparatus includes a conversion source image input interface, a style reference image input interface, an encoder-decoder network, a style extraction network, a combining unit, and a converted image output unit. The conversion source image input interface inputs an image of a conversion source. The style reference image input interface inputs a style reference image. The encoder-decoder network is a convolutional neural network that converts an image of the conversion source to a converted image based on a result of learning in advance. The style extraction network is a convolutional neural network that extracts a style vector indicating the style of the style reference image. The combining unit combines the style vector extracted by the style extraction network with an intermediate layer of the encoder-decoder network. The converted image output unit acquires the converted image from the encoder-decoder network and outputs the converted image.

When the technique of the image style conversion apparatus is applied to producing data for producing a sheet-like medium, it may be difficult to perform producing based on the output producing data depending on the type of producing (producing type). For example, when cutting data, which is producing data for cutting out a pattern from the medium, is output based on an image of a style in which the outline shape of the pattern is unclear, a cutting machine cannot appropriately cut the outline of the pattern based on the cutting data.

In view of the foregoing, an example of an object of this disclosure is to provide a producing data output system and a storage medium storing a display program that contribute to preventing output of producing data that is not suitable for producing a sheet-like medium by using an image subjected to style conversion.

According to one aspect, this specification discloses a producing data output system configured to output producing data for producing a sheet-like medium. The producing data output system includes a controller. The controller acquires a target image. The controller performs style conversion on the target image to generate a converted image of a selected style. The selected style is selected from a plurality of types of image styles including a first style and a second style. This contributes to the user selecting a desired style. The controller outputs producing data based on the converted image. The producing data is data for producing the medium by a selected producing type. The selected producing type is selected from one or more producing candidates associated with the selected style. The one or more producing candidates are among a plurality of producing types including a first producing type and a second producing type. In a case where the selected style is the first style, the one or more producing candidates include the first producing type and do not include the second producing type. In a case where the selected style is the second style, the one or more producing candidates include the first producing type and the second producing type. In the producing data output system according to the first aspect, the associated producing type differs from each other depending on the selected style. The output process of outputting the producing data contributes to preventing output of the producing data to be produced in the second producing type based on the converted image converted to the first style. That is, in the output process, the producing data which is not suitable for producing is not output. Thus, the output process contributes to avoiding a situation in which the medium is not appropriately produced due to the medium being produced by outputting the producing data for producing in the second producing type from the converted image subjected to the style conversion based on the first style.

According to another aspect, this specification also discloses a producing data output system configured to output producing data for producing a sheet-like medium. The producing data output system includes a controller. The controller acquires a selected producing type. The selected producing type is selected from a plurality of producing types including a first producing type and a second producing type. The controller acquires a target image. The controller performs style conversion on the target image to generate a converted image of a selected style. The selected style is selected from one or more style candidates associated with the selected producing type. The one or more style candidates are among a plurality of types of image styles including a first style and a second style. In a case where the selected producing type is the first producing type, the one or more style candidates include the first style and the second style. In a case where the selected producing type is the second producing type, the one or more style candidates include the second style and do not include the first style. The controller outputs producing data based on the converted image. The producing data is data for producing the medium by the selected producing type. In the producing data output system according to this aspect, the associated style differs from each other depending on the selected producing type. The producing data output system contributes to preventing style conversion of the target image to the first style in a case where the selected producing type of the producing data output system is the second producing type. Thus, the style conversion process contributes to avoiding that the target image is subjected to style conversion to a style that is not suitable for producing. Thus, the producing data output system contributes to avoiding a situation in which the medium is not appropriately produced due to the medium being produced by outputting the producing data for producing in the second producing type from the converted image subjected to the style conversion based on the first style.

According to still another aspect, this specification also discloses a producing data output system configured to output producing data for producing a sheet-like medium. The producing data output system includes a display and a controller. The controller performs style conversion on a target image to generate a converted image of a selected style. The selected style is selected from a plurality of types of image styles including a first style and a second style. The controller displays the converted image on the display. This process contributes to allowing the user to visually check the converted image. The controller displays one or more producing candidates associated with the selected style. The one or more producing candidates are among a plurality of producing types including a first producing type and a second producing type. This process contributes to allowing the user to visually check the one or more producing candidates and select the desired producing type. In a case where the selected style is the first style, the one or more producing candidates include the first producing type and do not include the second producing type. In a case where the selected style is the second style, the one or more producing candidates include the first producing type and the second producing type. The controller displays a producing image based on the converted image. The producing image represents producing data for producing the medium by a selected producing type that is selected from the one or more producing candidates. In the producing data output system according to this aspect, the associated producing type differs from each other depending on the selected style. The producing candidate display process contributes to allowing the user to easily select the selected producing type from the one or more producing candidates. That is, in the producing data output system, producing type that is not suitable for the selected style is not selected. Thus, the producing candidate display process contributes to avoiding a situation in which the medium is not appropriately produced due to the medium being produced by outputting the producing data for producing in the second producing type from the converted image subjected to the style conversion based on the first style.

According to still another aspect, the present disclosure discloses a non-transitory computer-readable storage medium storing a display program including a set of program instructions for a terminal apparatus of a producing data output system configured to output producing data for producing a sheet-like medium. The set of program instructions, when executed by a controller of the terminal apparatus, causes the terminal apparatus to perform: a converted image display process of performing style conversion on a target image to acquire a converted image of a selected style, the selected style being selected from a plurality of types of image styles including a first style and a second style, and displaying the converted image on the display; a producing candidate display process of displaying one or more producing candidates associated with the selected style, the one or more producing candidates being among a plurality of producing types including a first producing type and a second producing type, in a case where the selected style is the first style, the one or more producing candidates including the first producing type and not including the second producing type, in a case where the selected style is the second style, the one or more producing candidates including the first producing type and the second producing type; and a producing image display process of displaying a producing image based on the converted image, the producing image representing producing data for producing the medium by a selected producing type selected from the one or more producing candidates. In the display program according to this aspect, the associated producing type differs from each other depending on the selected style. The producing candidate display process of the display program contributes to allowing the user to easily select the selected producing type from one or more producing candidates. That is, when the display program is performed, producing type that is not suitable for the selected style is not selected. Thus, the producing candidate display process of the display program contributes to avoiding a situation in which the medium is not appropriately produced due to the medium being produced by outputting the producing data for producing in the second producing type from the converted image subjected to the style conversion based on the first style.

### BRIEF DESCRIPTION OF DRAWINGS

FIG. 1 is a block diagram showing a schematic configuration of a producing data output system 1 including an embroidery sewing machine 2, a cutting machine 3, a printer 9, a terminal apparatus 7, and a producing data output apparatus 4.

FIG. 2 is a flowchart of a main process performed by the producing data output system 1.

FIG. 3 is an explanatory diagram of a part of a table T.

FIG. 4 is an explanatory diagram of another part of the table T.

FIG. 5 is an explanatory diagram of an image J1.

FIG. 6 is an explanatory diagram of a target image G and converted images G1 to G7 acquired by performing style conversion on the target image G.

FIG. 7 is an explanatory diagram of a second image J2.

FIG. 8 is an explanatory diagram of a first image J3.

FIG. 9 is an explanatory diagram of an image J4.

FIG. 10 is an explanatory diagram of a parameter setting image J6.

FIG. 11 is an explanatory diagram of a parameter setting image J7.

FIG. 12 is an explanatory diagram of an image J8.

FIG. 13 is an explanatory diagram of an image J9.

FIG. 14 is a flowchart of a main process performed by the producing data output system 1.

FIG. 15 is an explanatory diagram of an image J10.

FIG. 16 is an explanatory diagram of an image J11.

FIG. 17 is an explanatory diagram of an image J12.

### DESCRIPTION

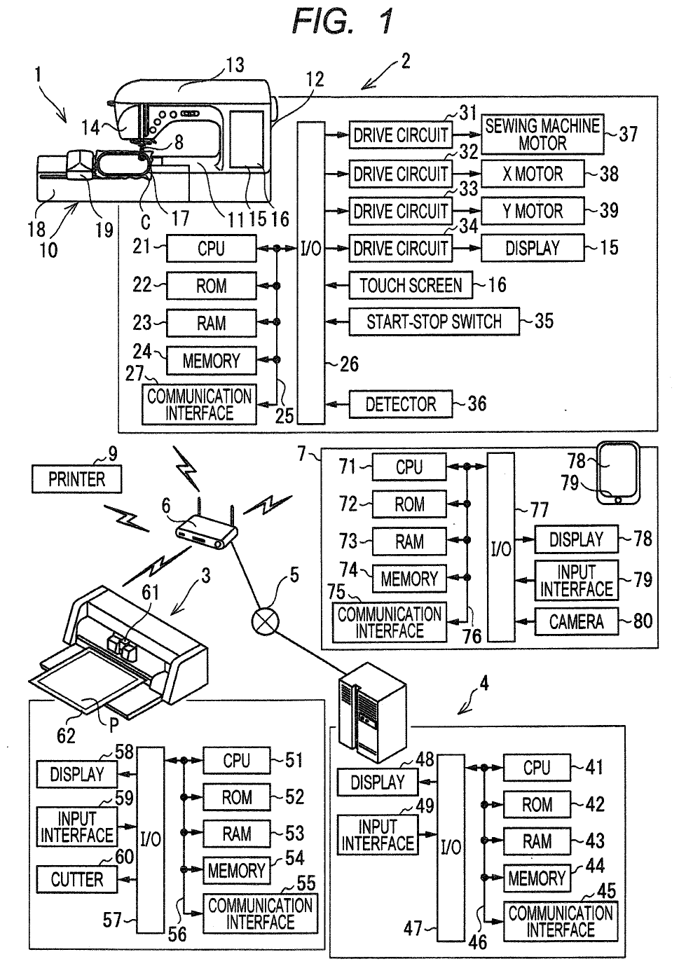

An embodiment of the present disclosure will be described with reference to the drawings. As shown in FIG. 1, a producing data output system 1 (hereinafter, referred to as “system 1”) includes an embroidery sewing machine 2 (hereinafter, referred to as “sewing machine 2”), a cutting machine 3, a printer 9, a terminal apparatus 7, and a producing data output apparatus 4 (hereinafter referred to as “apparatus 4”). The system 1 has a function of outputting producing data used for producing a sheet-like medium by a producing apparatus based on a target image selected by a user via the terminal apparatus 7. In the system 1 of the present embodiment, a producing apparatus is selected from the sewing machine 2, the cutting machine 3, and the printer 9. In a case where the producing apparatus is the sewing machine 2, the producing data is sewing data (embroidery data) for sewing an embroidery pattern on a medium. In a case where the producing apparatus is the cutting machine 3, the producing data is cutting data for cutting a medium. In a case where the producing apparatus is the printer 9, the producing data is printing data to be printed on a medium. The medium is a sheet-like fabric, for example.

The sewing machine 2 is a sewing machine configured to perform embroidery sewing in accordance with producing data that is received via a network 5 and an access point 6. The sewing machine 2 includes a bed 11, a pillar 12, an arm 13, a head 14, and a movement mechanism 10. The bed 11 is a base portion of the sewing machine 2 extending in a left-right direction. The pillar 12 is provided upright from a right end portion of the bed 11. A display 15 and a touch panel 16 are provided on a front surface of the pillar 12. The arm 13 extends leftward from an upper end of the pillar 12 so as to face the bed 11. The head 14 is a portion connected to a left end portion of the arm 13. The sewing machine 2 includes a needle bar 8, a presser bar (not shown), and so on, at the head 14. A sewing needle is detachably attached to a lower end of the needle bar 8.

The movement mechanism 10 is configured to move a medium C held by an embroidery frame 17 relative to the needle bar 8. The movement mechanism 10 includes a main body case 18 and a carriage 19. When embroidery sewing is performed, the user attaches, to the carriage 19, one embroidery frame 17 selected from a plurality of types of embroidery frames 17 having different sizes. The embroidery frame 17 is moved by the movement mechanism 10 to a needle drop point indicated by an XY coordinate system (embroidery coordinate system) unique to the sewing machine 2. The sewing machine 2 forms an embroidery pattern on the medium C held by the embroidery frame 17 by the needle bar 8 moving up and down in conjunction with movement of the embroidery frame 17.

The cutting machine 3 is configured to perform a process of cutting a sheet-like medium in accordance with producing data received via the network 5 and the access point 6. The printer 9 is configured to print an image on a medium in accordance with producing data received via the network 5 and the access point 6. The printer 9 is an inkjet printer that includes a platen (not shown) that is conveyed in a sub-scanning direction and a print head (not shown) that is conveyed in a main scanning direction, and performs printing by ejecting ink onto a medium placed on the platen with the print head. The apparatus 4 is configured to generate a converted image acquired by performing style conversion on the target image, based on the target image selected by the terminal apparatus 7. The apparatus 4 is configured to output producing data used for producing the sheet-like medium by the producing apparatus based on the converted image. The terminal apparatus 7 is, for example, a smartphone, and is configured to be operated by the user of the system 1 and to receive an instruction for generating producing data.

The electrical configurations of the sewing machine 2, the cutting machine 3, the apparatus 4, and the terminal apparatus 7 of the system 1 will be described in order. The sewing machine 2 includes a CPU 21, a ROM 22, a RAM 23, a memory 24, an input-output (I/O) interface 26, and a communication interface 27. The CPU 21 is connected to the ROM 22, the RAM 23, the memory 24, the input-output interface 26, and the communication interface 27 via a bus 25. Drive circuits 31, 32, 33 and 34, the touch panel 16, a start-stop switch 35, and a detector 36 are connected to the input-output interface 26. The detector 36 is configured to detect that the embroidery frame 17 is attached to the movement mechanism 10 and output a detection result corresponding to the type of the embroidery frame 17. The memory 24 stores various setting values. The memory 24 stores sewing data corresponding to each of a plurality of patterns that are candidates for the pattern to be sewn by the sewing machine 2.

A sewing machine motor 37 is connected to the drive circuit 31. The drive circuit 31 drives the sewing machine motor 37 in accordance with a control signal from the CPU 21. The needle bar 8 moves up and down in accordance with the driving of the sewing machine motor 37. An X motor 38 is connected to the drive circuit 32. A Y motor 39 is connected to the drive circuit 33. The drive circuits 32 and 33 drive the X motor 38 and the Y motor 39, respectively, in accordance with control signals from the CPU 21. Due to the driving of the X motor 38 and the Y motor 39, the embroidery frame 17 attached to the movement mechanism 10 is moved in the left-right direction (X direction) and the front-rear direction (Y direction) by the movement amount corresponding to the control signal. The drive circuit 34 displays an image on the display 15 in accordance with a control signal from the CPU 21. The communication interface 27 connects the sewing machine 2 to the network 5 via the access point 6. The CPU 21 performs data transmission and reception with other devices connected to the network 5, for example, the cutting machine 3, the printer 9, the apparatus 4, and the terminal apparatus 7, via the communication interface 27.

The cutting machine 3 performs a process of cutting a sheet-like medium in accordance with producing data received via the network 5 and the access point 6. The cutting machine 3 cuts the medium by using a cutting blade of a cartridge 61. The cutting machine 3 includes a CPU 51, a ROM 52, a RAM 53, a memory 54, a communication interface 55, an input-output (I/O) interface 57, a display 58, an input interface 59, and a cutter 60. The CPU 51 is connected to the ROM 52, the RAM 53, the memory 54, the input-output interface 57, and the communication interface 55 via a bus 56. The CPU 51 performs overall control of the cutting machine 3. The memory 54 stores a cutting program to be performed by the CPU 51, cutting data for cutting a medium P, and so on. The communication interface 55 is an interface for connecting the cutting machine 3 to the network 5 via the access point 6. The CPU 51 performs data transmission and reception with other devices connected to the network 5, for example, the sewing machine 2, the printer 9, the apparatus 4, and the terminal apparatus 7, via the communication interface 55.

The display 58, the input interface 59, and the cutter 60 are connected to the input-output interface 57. The display 58 is configured to display an image, and is, for example, a liquid crystal display. The input interface 59 is a touch panel provided on the surface of the display 58. The cutter 60 includes a conveyance mechanism, a first movement mechanism, and a second movement mechanism. The conveyance mechanism conveys a mat 62, which holds the medium P on the upper surface thereof, in the sub-scanning direction. The first movement mechanism moves the cartridge 61 in the main scanning direction. The second movement mechanism moves the cartridge 61 in the upper-lower direction perpendicular to the main scanning direction and the sub-scanning direction. The CPU 51 controls the cutter 60 based on the cutting data, as follows. The CPU 51 controls the second movement mechanism to move the cartridge 61 downward and bring the cutter blade into contact with the medium P. The CPU 51 controls the conveyance mechanism and the first movement mechanism in this state to move the mat 62 and the cartridge 61. Accordingly, the cutting blade moves relative to the medium P in the main scanning direction and the sub-scanning direction, and cuts the medium P.

The apparatus 4 is a server configured to communicate with at least the terminal apparatus 7. The apparatus 4 includes a CPU 41, a ROM 42, a RAM 43, a memory 44, a communication interface 45, an input-output (I/O) interface 47, a display 48, and an input interface 49. The CPU 41 is electrically connected to the ROM 42, the RAM 43, the memory 44, the communication interface 45, and the input-output interface 47 via a bus 46. The CPU 41 performs control of the apparatus 4. The ROM 42 stores a boot program, a BIOS, and so on. The RAM 43 stores temporary data. The memory 44 stores a conversion network, a table T, and various setting values. The communication interface 45 is an interface for connecting the apparatus 4 to the network 5. The CPU 41 performs data transmission and reception with other devices connected to the network 5, for example, the sewing machine 2, the cutting machine 3, the printer 9, and the terminal apparatus 7, via the communication interface 45. The display 48 and the input interface 49 are connected to the input-output interface 47. The display 48 is configured to display an image, and is, for example, a liquid crystal display. The input interface 49 is a keyboard and a mouse.

The apparatus 4 is configured to perform style conversion on a target image by using a trained model. The conversion network stored in the memory 44 is a machine learning model that performs style conversion on the target image. The conversion network is, for example, a neural network called a high-resolution network. When a target image is input, the conversion network performs an operation on the target image by using a plurality of operation parameters to generate and output a converted image. The target image is a photographic image, for example. The converted image is an image having a particular style while maintaining the shape of an object. The particular style is, for example, at least a style or a feature of a painting such as an illustration. The conversion network may be prepared for each type of style, and may be configured to generate a converted image of a particular style corresponding to the conversion network based on the target image. One conversion network may be prepared for a plurality of types of styles, and may be configured to generate a converted image of a particular style based on the particular style and the target image. The CPU 41 may perform style conversion. In a case where the apparatus 4 includes a GPU, the GPU may perform style conversion in accordance with an instruction of the CPU 41.

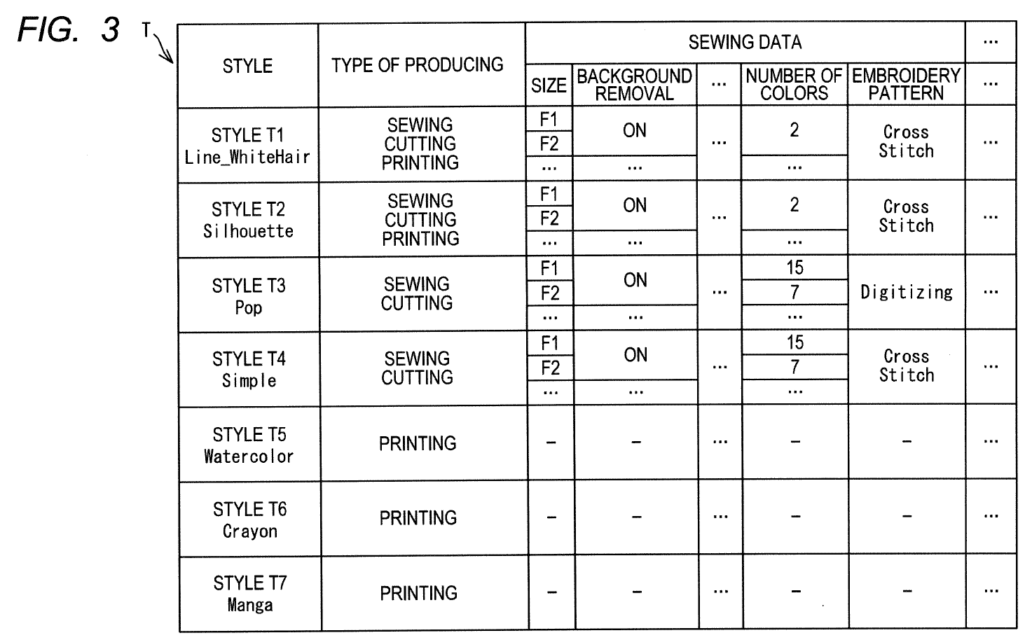

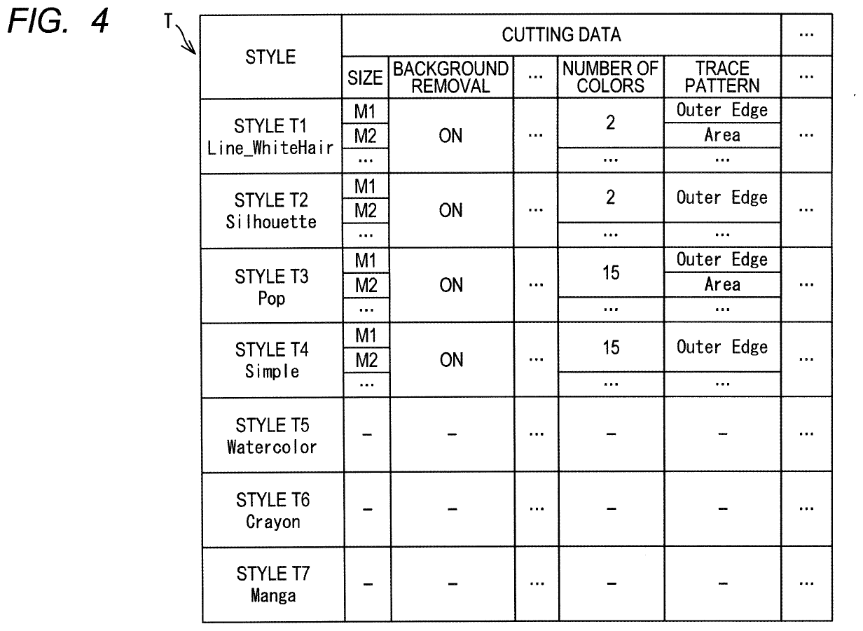

As shown in FIGS. 3 and 4, the table T stores styles, producing types suitable for the styles, and initial values of a plurality of types of parameters used for outputting producing data in association with each other, for each of the plurality of producing types. In the system 1 of the present embodiment, seven styles from style T1 to style T7 are prepared in advance and stored in the table T. The style T1 is a style called Line_WhiteHair, and outputs a black-and-white image in which the outline of an object such as a person is represented in black, based on the target image. The style T2 is a style called Silhouette, and outputs a black-and-white image representing a silhouette of an object based on the target image. The style T3 is a style called Pop, and outputs an image in which an object is represented by a pop-tone illustration based on the target image. The style T4 is a style called Simple, and outputs a simple illustration of an object based on the target image. The style T5 is a style called Watercolor, and outputs a watercolor painting-like image based on the target image. The style T6 is a style called Crayon, and outputs a crayon-style image based on the target image. The style T7 is a style called Manga, and outputs a cartoon-style image based on the target image. The style T3 is also referred to as a first style, and the style T2 is also referred to as a second style.

The styles T1 and T2 are associated with sewing, cutting, and printing as the producing type. The styles T3 and T4 are associated with the sewing and the cutting as the producing type. The styles T5 to T7 are associated with the printing as the producing type. That is, in the system 1, the associated producing type differs depending on the type of style. The sewing is also referred to as first producing type, and sewing data is also referred to as first producing data. The printing is also referred to as second producing type, and printing data is also referred to as second producing data. The cutting is also referred to as a third producing type, and cutting data is also referred to as third producing data. The first style (T3) is associated with the first producing type and the third producing type, but is not associated with the second producing type. The second style (T2) is associated with the first producing type, the second producing type, and the third producing type.

As shown in FIG. 3, the parameters when the producing data is sewing data include “background removal”, “number of colors”, and “embroidery pattern”. The “background removal” indicates whether the background is removed when the producing data is output. In the setting of “background removal”, “ON” indicates that the background is removed and the producing data is output, and “OFF” indicates that the producing data is output without removing the background. The “number of colors” is the number of colors of threads used for sewing, and is set in accordance with the number of colors of the converted image. The number of colors in the case of a monochrome image is 2. The number of colors in the case of a color image is a number corresponding to the size of a producing region. In the table T, as an example, the number of colors in the case of a size F1 is set to 15, and the number of colors in the case of a size F2 smaller than the size F1 is set to 7. The “embroidery pattern” indicates the type of stitches. The initial value of the background removal and the initial value of the embroidery pattern are set for each style, regardless of the size corresponding to the producing region. The initial value of the number of colors is set in accordance with the selected style and the size corresponding to the producing region.

As shown in FIG. 4, the parameters when the producing data is cutting data include “background removal”, “number of colors”, and “Trace pattern”. The initial value of the “background removal” is “ON” regardless of the selected style and the size corresponding to the producing region. The number of colors is used for setting a cutting position and is set according to the number of colors of the converted image. The number of colors in the case of a monochrome image is 2. The number of colors in the case of a color image is 15. The initial value of the number of colors is set according to the selected style. The “Trace pattern” is a parameter for determining a cutting position. As the “Trace pattern”, “Outer Edge” or “Area” is set. The “Outer Edge” is a trace pattern in which the outer contour of an object in the converted image is set as cutting positions. The “Area” is a trace pattern in which the contour of an object for each color in the converted image is set as cutting positions. The “Trace pattern” is set in accordance with the selected style and the size corresponding to the producing region. Although not shown, the table T also stores a plurality of types of parameters when the producing data is printing data.

The terminal apparatus 7 includes a CPU 71, a ROM 72, a RAM 73, a memory 74, a communication interface 75, and an input-output (I/O) interface 77. The CPU 71 performs control of the terminal apparatus 7. The CPU 71 is electrically connected to the ROM 72, the RAM 73, the memory 74, the communication interface 75, and the input-output interface 77 via a bus 76. The ROM 72 stores various programs and setting values. The RAM 73 stores temporary data. The memory 74 is a nonvolatile storage device. The memory 74 stores various setting values necessary for performing a main process. The communication interface 75 is an interface for connecting the terminal apparatus 7 to the network 5. The CPU 71 performs data transmission and reception with other devices connected to the network 5, for example, the sewing machine 2, the cutting machine 3, the printer 9, and the apparatus 4, via the communication interface 75. The input-output interface 77 is connected to a display 78, an input interface 79, and a camera 80. The display 78 is a liquid crystal display, for example. The input interface 79 is a touch panel, for example, and is used to input various instructions. The camera 80 is a well-known CMOS image sensor, for example.

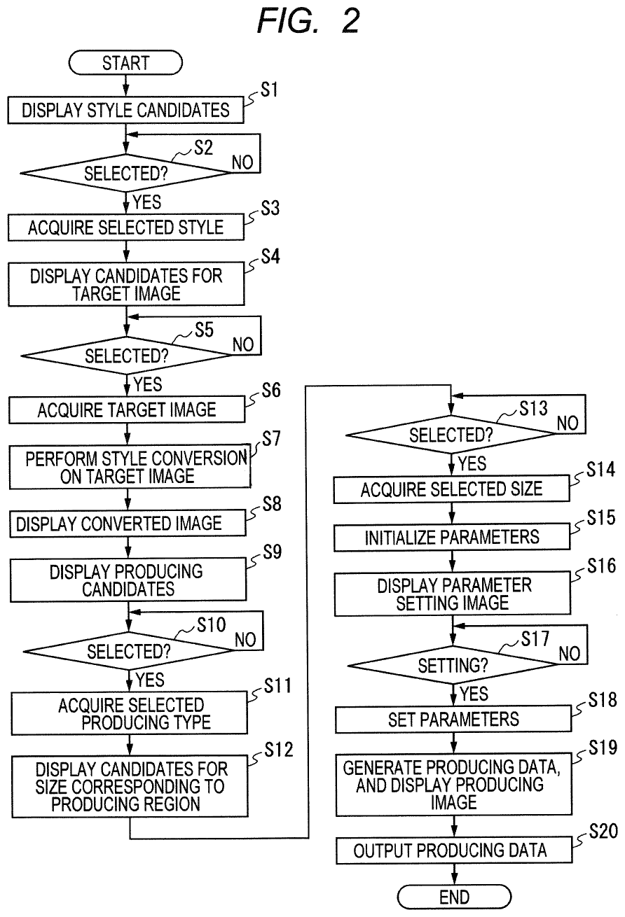

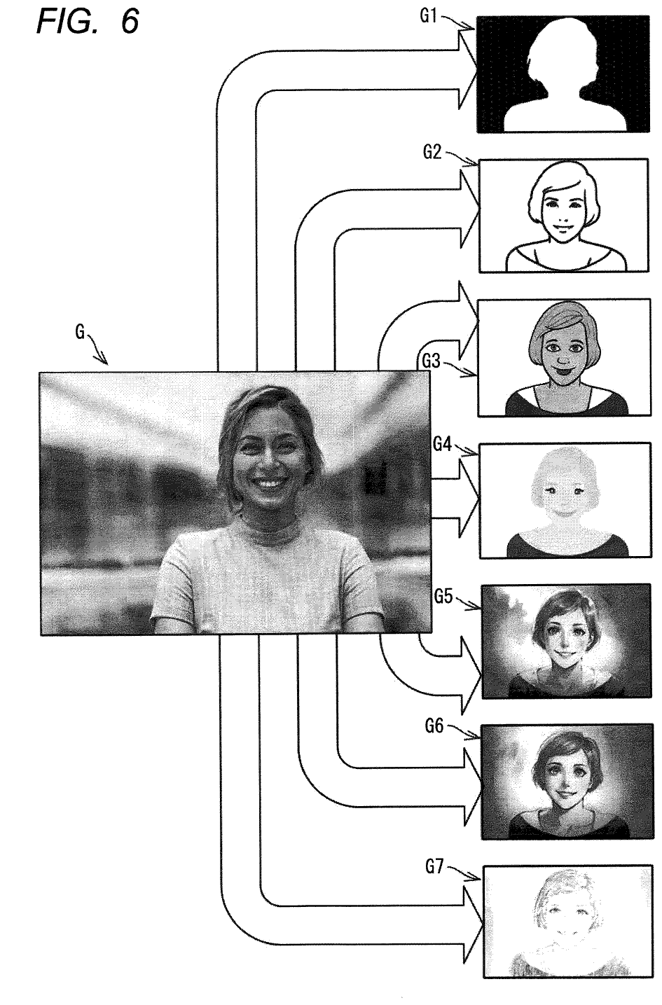

The main process performed in the system 1 will be described with reference to FIGS. 2 to 13. A case where cutting data is generated based on a target image G of FIG. 6 is referred to as a first specific example, and a case where sewing data is generated based on the target image G is referred to as a second specific example. The target image G is a photograph of a blond woman wearing short-sleeve clothes. The main process is performed when the user operates the terminal apparatus 7 to input a start instruction to start the main process. In response to detecting the start instruction, the CPU 71 of the terminal apparatus 7 reads out a display program for performing the main process stored in the program storage area of the ROM 72 to the RAM 73. The CPU 71 performs the following steps in cooperation with the CPU 41 of the apparatus 4 in accordance with instructions included in the display program read out to the RAM 73. When the power is turned on, the CPU 41 of the apparatus 4 reads out a program necessary for performing the main process to the RAM 43. The CPU 41 performs producing in accordance with instructions included in the program read out to the RAM 43. Various parameters necessary for performing the main process are stored in the memories 74 and 44. Various data acquired in the main process are appropriately stored in the RAMs 73 and 43.

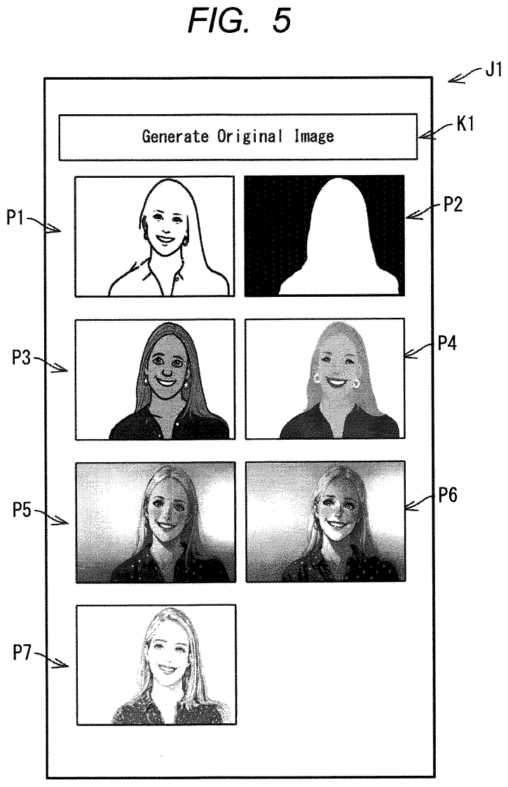

As shown in FIG. 2, the CPU 71 of the terminal apparatus 7 displays style candidates on the display 78 (S1). As shown in FIG. 5, in S1, the CPU 71 displays an image J1 on the display 78. As converted images serving as samples of the seven types of styles, the image J1 displays an image P1 of the style T1, an image P2 of the style T2, an image P3 of the style T3, an image P4 of the style T4, an image P5 of the style T5, an image P6 of the style T6, and an image P7 of the style T7. The image J1 displays a key object K1. The key object K1 is selected to input an instruction to generate an original image to which the selected style is applied.

The CPU 71 determines whether selection of the key object J1 is detected in a state where any one of the images P1 to P7 displayed in the image J1 is selected (S2). In response to not detecting selection of the key object K1 (S2: NO), the CPU 71 waits until selection of the key object K1 is detected. The user selects an image representing a desired style from the images P1 to P7, and then selects the key object K1. In the first specific example, the image P2 is selected (S2: YES), and the CPU 71 acquires the style T2 as the selected style (S3). In the second specific example, the image P3 is selected (S2: YES), and the CPU 71 acquires the style T3 as the selected style (S3).

The CPU 71 displays candidates for the target image on the display 78 (S4). For example, the CPU 71 displays, on the display 78, images in a particular folder as candidates for the target image. The particular folder may be determined in advance, or may be selected or changed by the user. The CPU 71 determines whether selection of any of one or more candidates for the target image displayed on the display 78 is detected (S5). In response to detecting selection of none of the candidates for the target image (S5: NO), the CPU 71 waits until selection of any of the candidates for the target image is detected. The user selects a desired target image from the candidates for the target image. In the specific examples 1 and 2, the CPU 71 detects selection of the candidate for the target image (S5: YES), and acquires the image G of FIG. 6 as the target image (S6).

The system 1 performs a style conversion process of performing style conversion on the target image acquired in S6 based on a selected style selected from the plurality of types of image styles in S3 (S7). More specifically, the CPU 71 of the terminal apparatus 7 transmits the target image G acquired in S6 and the selected style acquired in S3 to the apparatus 4. The CPU 41 of the apparatus 4 inputs the target image G received from the apparatus 7 to the conversion network corresponding to the selected style to generate a converted image. The CPU 41 transmits the converted image and one or more producing candidates to the terminal apparatus 7. When the selected style is the style T1, the CPU 41 generates an image G1 as the converted image. When the selected style is the style T2, the CPU 41 generates an image G2 as the converted image. When the selected style is the style T3, the CPU 41 generates an image G3 as the converted image. When the selected style is the style T4, the CPU 41 generates an image G4 as the converted image. When the selected style is the style T5, the CPU 41 generates an image G5 as the converted image. When the selected style is the style T6, the CPU 41 generates an image G6 as the converted image. When the selected style is the style T7, the CPU 41 generates an image G7 as the converted image. The producing candidate is a producing type associated with the selected style among the producing types stored in the table T. The CPU 71 receives the converted image and the producing candidate transmitted from the apparatus 4. In the first specific example, the CPU 71 receives the image G2 of FIG. 6 and the sewing, the cutting, and the printing that are associated with the style T2. In the second specific example, the CPU 71 receives the image G3 of FIG. 6 and the sewing and the cutting that are associated with the style T3.

The CPU 71 displays, on the display 78, a converted image acquired by performing style conversion on the target image based on the selected style selected from the plurality of types of image styles in S2 (S8). The CPU 71 displays producing candidates acquired in S7 on the display 78 in a selectable manner (S9). The CPU 71 of the present example displays the producing candidates on the display 78 in a selectable manner, and does not display, on the display 78, a producing type other than the producing candidates among the plurality of producing types.

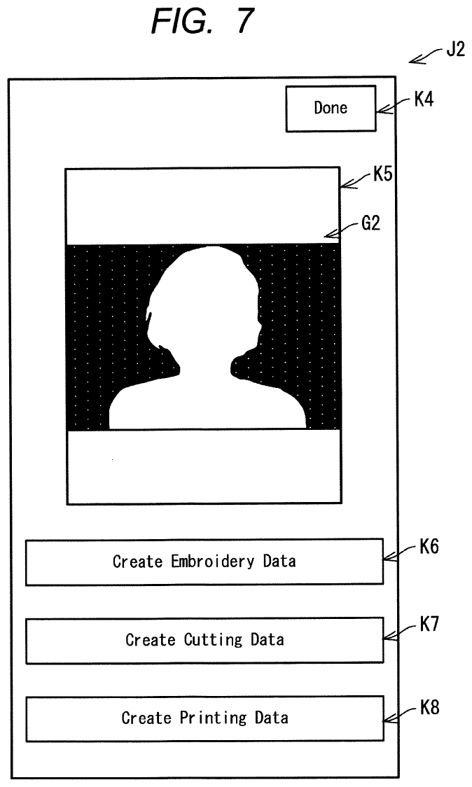

In the first specific example, the selected style is the style T2. Thus, as shown in FIG. 7, the CPU 71 displays a second image J2 indicating that the sewing data (embroidery data), the cutting data, and the printing data can be output. The second image J2 displays a field K5 and key objects K4, K6, K7 and K8. The field K5 displays the image G2. The key object K4 is selected when the selection of the producing type is finished. The key object K6 is a first object that is selected to input a first instruction to output sewing data (embroidery data) when the selected producing type is sewing. The key object K7 is a third object that is selected to input a third instruction to output cutting data when the selected producing type is cutting. The key object K8 is a second object that is selected to input a second instruction to output printing data when the selected producing type is printing. In the first specific example, the user selects the key object K7 as the desired producing type from the key objects K6 to K8 displayed on the display 78, and then selects the key object K4.

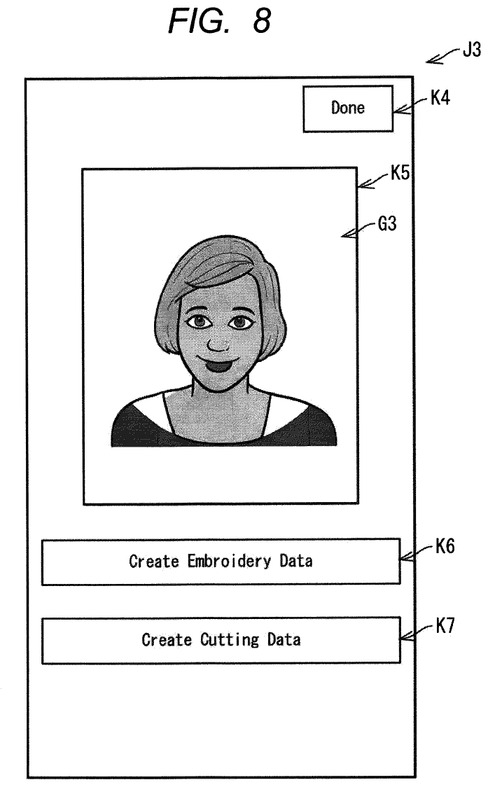

In the second specific example, the selected style is the style T3. Thus, as shown in FIG. 8, the CPU 71 displays a first image J3 indicating that the sewing data (embroidery data) and the cutting data can be output and that the printing data cannot be output. Here, the sewing data is producing data of sewing, the cutting data is producing data of cutting, and the printing data is producing data of printing. The first image J3 displays the field K5 and key objects K4, K6, and K7. The field K5 displays the image G3. The first image J3 does not display the key object K8 of the printing which is not associated with the style T3. That is, the first image J3 includes the key object K6 which is the first object, and does not include the key object K8 which is the second object. In the second specific example, the user selects the key object K6 as the desired producing type from the key objects K6 and K7 displayed on the display 78, and then selects the key object K4.

The CPU 71 determines whether selection of the key object K4 is detected in a state where any key object of the producing candidate is selected (S10). In response to not detecting selection of the key object K4 (S10: NO), the CPU 71 waits in S10. In the first specific example, in a state where the key object K7 is selected, the selection of the key object K4 is detected (S10: YES), and the CPU 71 acquires the cutting as the selected producing type (S11). In the second specific example, in a state where the key object K6 is selected, the selection of the key object K4 is detected (S10: YES), and the CPU 71 acquires the sewing as the selected producing type (S11).

The CPU 71 displays candidates for sizes corresponding to the producing region (S12). The size corresponding to the producing region may represent the size of a region in which producing is performed on the medium. In the present example, the size corresponding to the producing region is set for each producing type. In a case where the selected producing type is sewing (embroidery) that is performed by the sewing machine 2 and that uses sewing data for forming stitches on the medium as producing data, the size corresponding to the producing region is the size of the embroidery frame 17 that is attached to the sewing machine 2 and that holds the medium. Specifically, in a case where the selected producing type is sewing, the size corresponding to the producing region is the lengths of the embroidery frame 17 in the X direction and the Y direction. In a case where the selected producing type is the cutting that is performed by the cutting machine 3 and that uses cutting data for cutting the medium as the producing data, the size corresponding to the producing region is the size of the mat 62 that is used in the cutting and holds the medium. Specifically, in a case where the selected producing type is the cutting, the size corresponding to the producing region is the lengths of the mat 62 in the sub-scanning direction and the main scanning direction. In a case where the selected producing type is the printing, the size corresponding to the producing region is the lengths of the platen on which the medium is placed in the sub-scanning direction and the main scanning direction.

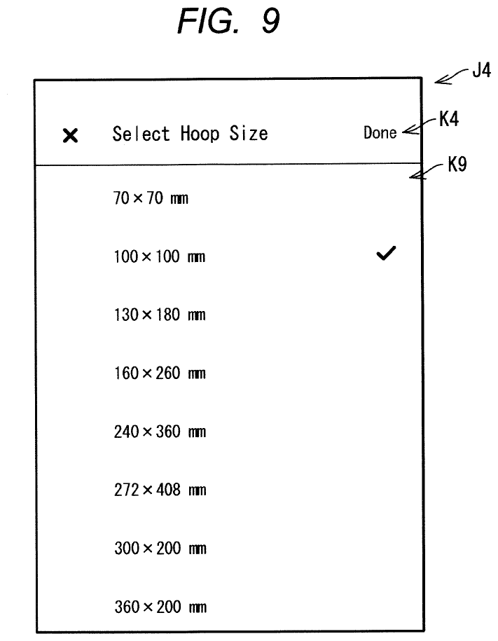

Although not shown, in the case of the first specific example, the CPU 71 displays the sizes of the plurality of types of mats 62 on the display 78 as candidates for the size corresponding to the producing region. In the case of the second specific example, as shown in FIG. 9, the CPU 71 displays an image J4 on the display 78. The image J4 includes the key object K4 and a field K9. The key object K4 is selected when selection of the size corresponding to the producing region is finished. The field K9 displays eight sizes of embroidery frames (hoops) as candidates for sizes corresponding to the producing region of the sewing. A check mark is given to the size that is being selected among the sizes displayed in the field K9. The CPU 71 may communicate with the sewing machine 2 and display the sizes of the embroidery frames 17 that are attachable to the sewing machine 2 as candidates for sizes corresponding to the producing region. The CPU 71 may communicate with the sewing machine 2 and select the size of the embroidery frame 17 attached to the sewing machine 2 as the initial size corresponding to the producing region.

The CPU 71 determines whether selection of the key object K4 is detected in a state where any one of the sizes corresponding to the plurality of types of producing regions displayed in the field K9 is selected (S13). In response to not detecting selection of the key object K4 (S13: NO), the CPU 71 waits until selection of the key object K4 is detected.

In the first specific example, when “305×305 mm” is selected as the size of the mat 62 (S13: YES), the system 1 acquires the selected size as the size corresponding to the producing region (S14). In the first specific example, “305× 305 mm” corresponds to a size M2 in the table T of FIG. 4. The system 1 initializes the parameters of the producing data according to the selected style, the selected producing type, and the size corresponding to the producing region (S15). Specifically, when initializing the parameters, the CPU 71 transmits, to the apparatus 4, the selected style, the selected producing type, and the size corresponding to the producing region. The CPU 41 of the apparatus 4 extracts, from the table T, the initial values of the parameters corresponding to the selected style, the selected producing type, and the size corresponding to the producing region, and transmits the extracted initial values to the terminal apparatus 7. In the first specific example, the CPU 71 receives the background removal “ON”, the number of colors “2”, and the trace pattern “Outer Edge” as the initial values of the plurality of types of parameters when outputting cutting data of the style T2 and the size M2 in the table T of FIG. 4, and sets the initial values of the parameters.

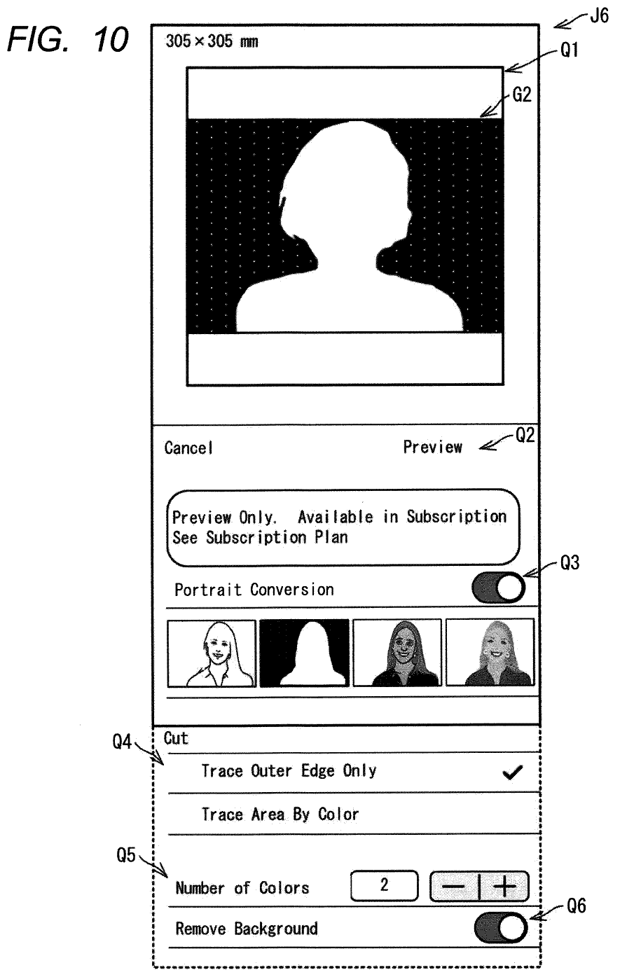

As shown in FIG. 10, the CPU 71 displays, on the display 78, a parameter setting image J6 for setting parameters used for generating producing data of the selected producing type (S16). The image J6 is a parameter setting image in a case where the selected producing type is the cutting, and includes fields Q1, Q4, Q5, a key object Q2, and switch objects Q3 and Q6. The field Q1 represents a producing region corresponding to the selected producing type. The image G2 is arranged in the field Q1. The image G2 is acquired by performing style conversion on the target image G based on the selected style T2. The image G2 is maximized with respect to the field Q1 with a constant aspect ratio, and is arranged such that the center of the image G2 coincides with the center of the field Q1.

The key object Q2 is selected to input an instruction to perform preview display of producing finish in a case where the producing data is generated based on the set parameters. The switch object Q3 represents a toggle switch for inputting an instruction to switch between ON and OFF to set whether to perform style conversion on the target image by using the selected style. In FIG. 10, the switch object Q3 is set to “ON” for performing style conversion on the target image by using the selected style. The field Q4 is a field for setting a cutting position, and more specifically, is a field for setting “Trace Outer Edge Only” or “Trace Area By Color”. The initial value of the parameter in the field Q4 is set to “Trace Outer Edge Only” based on the initial value acquired in S15.

The field Q5 is a field for setting the number of colors of the converted image. The initial value of the parameter in the field Q5 is set to the initial value “2” acquired in S15. The switch object Q6 represents a toggle switch for inputting an instruction to switch between ON and OFF to set whether to remove the background when performing style conversion on the target image by using the selected style. In FIG. 10, the switch object Q6 is set to “ON” for removing the background based on the initial value acquired in S15. The user checks conditions for outputting the cutting image, and operates the fields Q4 and Q5 and the switch object Q6 as necessary to input an instruction to change the settings. The CPU 71 determines whether selection of a key object for confirming the setting is detected (S17). In response to not detecting selection of the key object (S17: NO), the CPU 71 waits in S17. In response to detecting selection of the key object (S17: YES), the CPU 71 sets the parameters (S18).

In the second specific example, when “100×100 mm” is selected as the size of the embroidery frame 17 from the size candidates (S13: YES), the CPU 71 acquires the size corresponding to the producing region (S14). In the second specific example, “100×100 mm” corresponds to the size F2 in the table T of FIG. 3. In a similar manner to the first specific example, the system 1 initializes the parameters of the producing data according to the selected style, the selected producing type, and the size corresponding to the producing region (S15). In the second specific example, the CPU 71 receives the background removal “ON”, the number of colors “7”, and the embroidery pattern “Digitizing” as the initial values of the plurality of types of parameters when outputting sewing data of the style T3 and the size F2 in the table T of FIG. 3, and sets the initial values of the parameters.

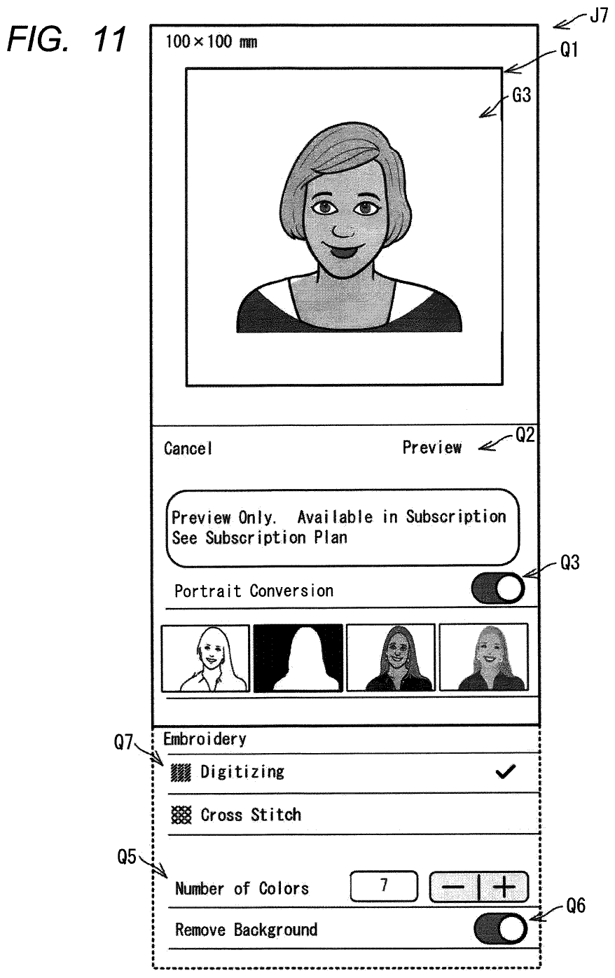

As shown in FIG. 11, the CPU 71 displays a parameter setting image J7 on the display 78 (S16). The image J7 is a parameter setting image in a case where the selected producing type is the sewing. The image J7 includes a field Q7, and the fields Q1 and Q5 and switch objects Q3 and Q6 similar to those of the image J6. The image G3 is arranged in the field Q1 of the image J7. The image G3 is acquired by performing style conversion on the target image G by using the selected style T3. The image G3 is maximized with respect to the field Q1 with a constant aspect ratio, and is arranged such that the center of the image G3 coincides with the center of the field Q1. The field Q7 is a field for setting an embroidery pattern, that is, a type of stitches. In the system 1 of the present embodiment, the field Q7 is a field for setting “Digitizing” or “Cross Stitch”. The initial value of the parameter in the field Q7 is set to the initial value “Digitizing” acquired in S15. The user checks conditions for outputting the sewing data, and operates the fields Q7 and Q5 and the switch object Q6 as necessary, to input an instruction to change the settings. The CPU 71 determines whether selection of a key object for confirming the setting is detected (S17). In response to not detecting selection of the key object (S17: NO), the CPU 71 waits in S17. In response to detecting selection of the key object (S17: YES), the CPU 71 sets the parameters (S18).

In response to detecting selection of the key object Q2, the system 1 generates producing data, and displays a producing image on the display 78 (S19). The producing image represents producing data for producing the medium by the selected producing type that is selected from the producing candidates based on the converted image. More specifically, the CPU 71 transmits the converted image and the plurality of types of parameters set in S18 to the apparatus 4. The apparatus 4 receives the plurality of types of parameters and the converted image transmitted from the terminal apparatus 7, and generates the producing data based on the plurality of types of parameters and the converted image. The apparatus 4 transmits the producing image representing the generated producing data to the terminal apparatus 7.

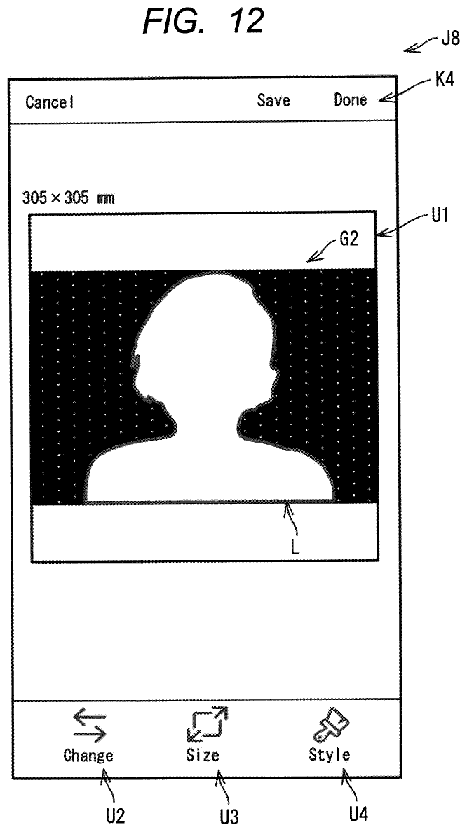

In the first specific example, the apparatus 4 transmits a producing image to the terminal apparatus 7. The producing image represents cutting data in which the contour (outer edge) in the image G2 is used as the cutting position. The cutting data is based on the image G2 and a plurality of types of parameters including the size “305×305 mm” corresponding to the producing region, the background removal “ON”, the number of colors “2”, and the trace pattern “Outer Edge”. As shown in FIG. 12, the CPU 71 receives the producing image transmitted from the apparatus 4, and displays an image J8 on the display 78. The image J8 includes key objects K4, U2, U3, U4, and a field U1. The key object U2 is selected to input an instruction to change the target image. The key object U3 is selected to input an instruction to change the size corresponding to the producing region. The key object U4 is selected to input an instruction to change the selected style. The field U1 displays the producing image. In a case where the producing type is cutting, the producing image is an image in which a line L indicating the cutting position is superimposed on the image G2. The user checks the producing image displayed in the field U1. When the user wishes to output the cutting data under the condition represented by the producing image, the user selects the key object K4. When the user wishes to change the condition of outputting the cutting data, the user selects one of the key objects U2, U3 and U4 according to the condition to be changed.

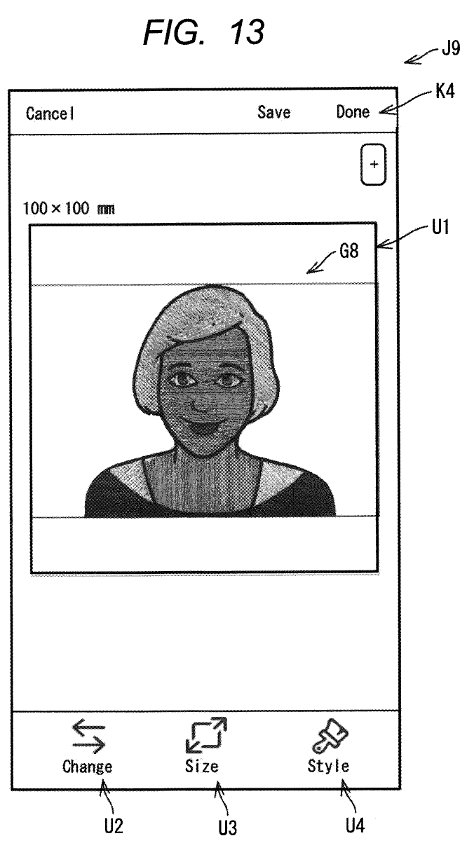

In the second specific example, the apparatus 4 transmits a producing image to the terminal apparatus 7. The producing image represents sewing data in which the illustration of the image G3 is represented with stitches of “Digitizing” of seven colors of threads. The sewing data is based on the image G3 and a plurality of types of parameters including the size “100×100 mm” corresponding to the producing region, the background removal “ON”, the number of colors “7”, and the embroidery pattern “Digitizing”. As shown in FIG. 13, the CPU 71 receives the producing image transmitted from the apparatus 4 and displays an image J9 on the display 78. The image J9 includes key objects K4, U2, U3, U4, and the field U1. In a case where the producing type is sewing, a producing image G8 displayed in the field U1 is an image indicating the finish of the embroidery. The user checks the producing image displayed in the field U1. When the user wishes to output the sewing data under the condition represented by the producing image, the user selects the key object K4. When the user wishes to change the condition of outputting the sewing data, the user selects one of the key objects U2, U3 and U4 according to the condition to be changed.

In response to detecting selection of the key object K4, the system 1 outputs the producing data based on the converted image (S20). The producing data is data for producing the medium by the selected producing type that is selected from one or more producing candidates associated with the selected style among the plurality of producing types. The system 1 outputs the producing data based on the converted image and the plurality of types of parameters, the initial values of which are set according to the selected style. The method of outputting the producing data may be set as appropriate. For example, the CPU 71 transmits an instruction to output the producing data to the apparatus 4. The apparatus 4 may transmit the producing data to the terminal apparatus 7 or to the producing apparatus connected to the terminal apparatus 7 based on the instruction received from the terminal apparatus 7. In the first specific example, the cutting data is transmitted to the cutting machine 3. The cutting machine 3 may perform a process of cutting the medium based on the cutting data received from the apparatus 4. In the second specific example, the sewing data is transmitted to the sewing machine 2. The sewing machine 2 may perform a process of forming stitches on the medium based on the sewing data received from the apparatus 4. When the producing type is printing, the apparatus 4 may transmit printing data to the printer 9. The printer 9 may perform a process of printing on the medium based on the printing data received from the apparatus 4. The system 1 then ends the main process.

In the style T5 to T7 of the above-described embodiment, the target image may be converted to a converted image having unclear outlines. In the main process, when any one of the styles T5 to T7 is selected, the printing is displayed as the producing candidate, and the sewing and the cutting are not displayed. Thus, the producing data other than printing data is not output based on the converted image having unclear outlines.

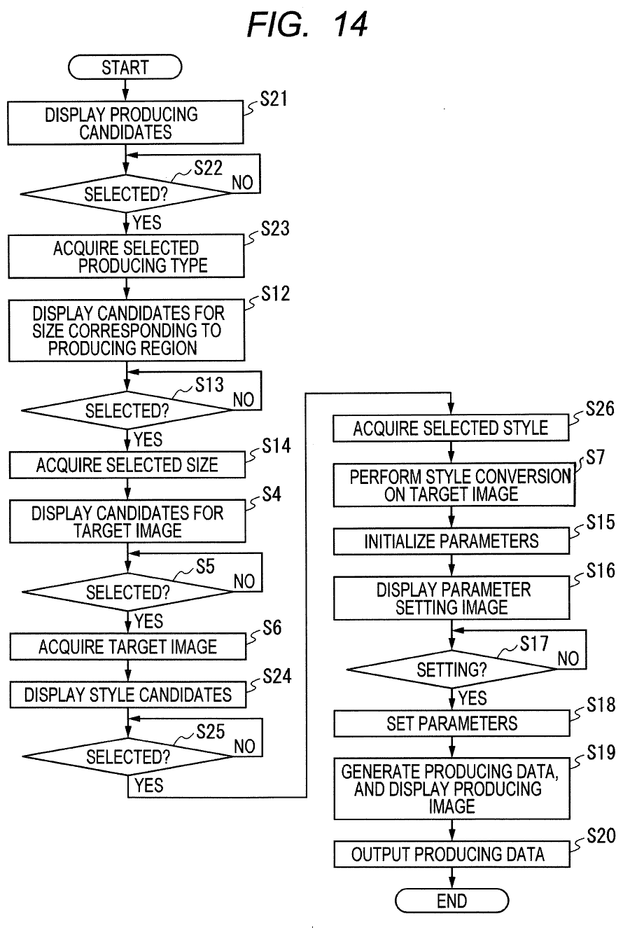

A main process of the system 1 according to a modification will be described with reference to FIGS. 14 to 16. The main process of the system 1 of the modification is different from the above-described embodiment in that the selected producing type is selected from producing candidates and then the selected style is selected. As in the above-described embodiment, the main process is performed when the user operates the terminal apparatus 7 to input a start instruction to start the main process. In response to detecting the start instruction, the CPU 71 of the terminal apparatus reads out, to the RAM 73, a display program stored in the program storage area of the ROM 72. The display program is a program for performing the main process. The CPU 71 performs the following steps in cooperation with the apparatus 4, in accordance with instructions included in the display program read to the RAM 73. In FIG. 14, the same step numbers are assigned to the same processes as those in the main process of the above-described embodiment. In the main process of the system 1 of the modification, after steps S21 to S23, steps from S12 to S14 and from S4 to S6 similar to the above-described embodiment are performed. In the main process of the system 1 of the modification, after steps from S24 to S26, steps S7 and S15 to S20 similar to the above-described embodiment are further performed. The same processes as those in the above-described embodiment will not be described, and processes different from those in the above-described embodiment will be described with reference to third, fourth, and fifth specific examples. The third specific example is a case where sewing data is generated by using the image G of FIG. 6 as the target image. The fourth specific example is a case where cutting data is generated by using the image G of FIG. 6 as the target image. The fifth specific example is a case where printing data is generated by using the image G of FIG. 6 as the target image.

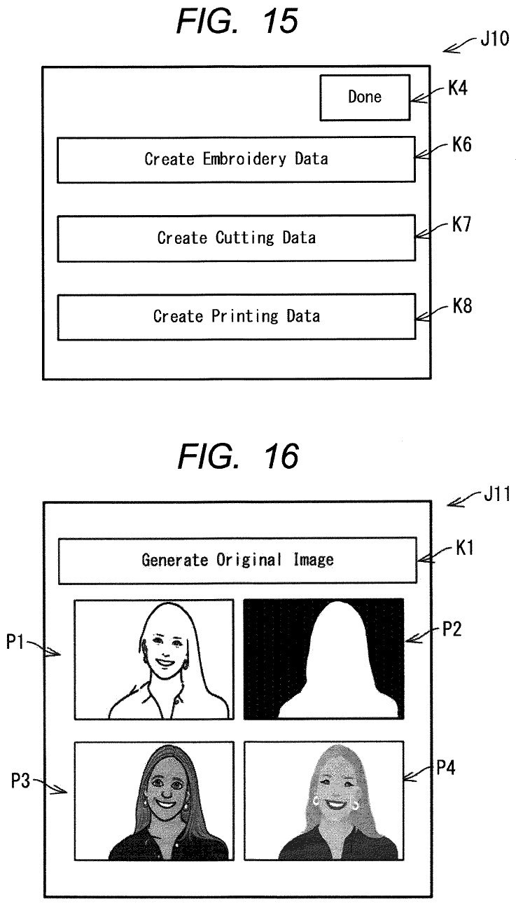

As shown in FIG. 14, the CPU 71 displays producing candidates on the display 78 (S21). In S21, the CPU 71 displays the producing candidates corresponding to the types of producing data that can be output by the system 1. Specifically, as shown in FIG. 15, the CPU 71 displays an image J10. The image J10 includes key objects K4, K6, K7 and K8. After any one of the key objects K6, K7 and K8 is selected, the CPU 71 determines whether selection of the key object K4 is detected (S22). In response to not detecting selection of the key object K4 (S22: NO), the CPU 71 waits in S22 until selection of the key object K4 is detected. In response to detecting selection of the key object K4 (S22: YES), the CPU 71 acquires a selected producing type that is selected from the plurality of producing types including the first producing type and the second producing type (S23). In the third specific example, the CPU 71 detects selection of the key object K4 after the key object K6 is selected (S22: YES), and acquires the sewing, that is, the first producing type as the selected producing type (S23). In the fourth specific example, the CPU 71 detects selection of the key object K4 after the key object K7 is selected (S22: YES), and acquires the cutting, that is, the third producing type as the selected producing type (S23). In the fifth specific example, the CPU 71 detects selection of the key object K4 after the key object K8 is selected (S22: YES), and acquires the printing, that is, the second producing type as the selected producing type (S23).

In S24, the CPU 71 displays the style candidates corresponding to the selected producing type on the display 78 (S24). Specifically, in S24, the CPU 71 transmits the selected producing type to the apparatus 4. The apparatus 4 extracts, from the table T, style candidates corresponding to the selected producing type received from the terminal apparatus 7, and transmits the extracted style candidates to the terminal apparatus 7. The CPU 71 receives the style candidates transmitted from the apparatus 4 and displays the style candidates on the display 78. In the third specific example where the selected producing type is the sewing, that is, the first producing type, the style candidates include the style T3 as the first style, the style T2 as the second style, the style T1, and the style T4. In the fourth specific example where the selected producing type is the cutting, that is, the third producing type, the style candidates include the styles T1 to T4 in the same manner. In the specific examples 3 and 4, the CPU 71 displays an image J11 shown in FIG. 16. The image J11 includes the key object K1 and the images P1 to P4 as images of the styles corresponding to the sewing and the cutting. The image J11 does not include the images P5 to P7 of the styles not corresponding to the sewing and the cutting. The user selects an image representing a desired style from the images P1 to P4 of the image J11, and then selects the key object K1.

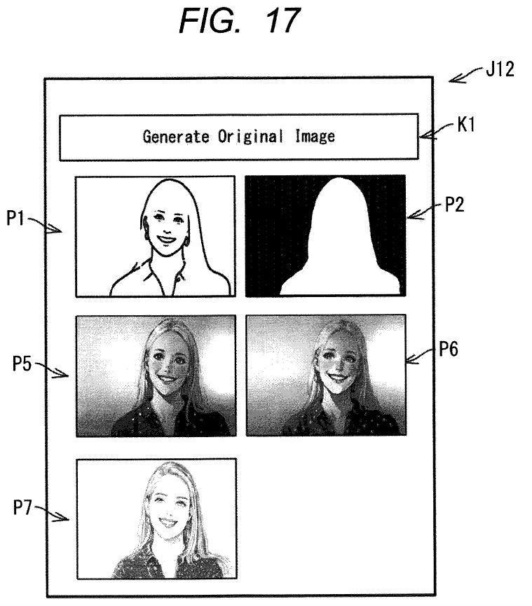

In the fifth specific example where the selected producing type is the printing, that is, the second producing type, the style candidates include the style T2 as the second style, the style T1, and the styles T5, T6 and T7, and do not include the style T4 and the style T3 which is the first style. In the fifth specific example, the CPU 71 displays an image J12 shown in FIG. 17. The image J12 includes the key object K1 and the images P1, P2, P5, P6 and P7 as images of the styles corresponding to printing. The image J12 does not include the images P3 and P4 of the styles not corresponding to the printing. The user selects an image representing a desired style from the images P1, P2, P5, P6 and P7 of the image J12, and then selects the key object K1.

In the modification, the converted image that has been style-converted in S7 is displayed on the display 78 in S16. In the third specific example, when the image P3 is selected (S25: YES, S26), the parameter setting image J7 of FIG. 11 is displayed in S16, and the processes similar to the above-described embodiment are performed. In the fourth specific example, when the image P2 is selected (S25: YES, S26), the parameter setting image J6 of FIG. 10 is displayed in S16, and the processes similar to the above-described embodiment are performed. Although not shown, in the fifth specific example, when the image P5 is selected (S25: YES, S26), a parameter setting image in the case where the producing type is the printing is displayed, and the processes similar to the above-described embodiment are performed.

In the above-described embodiment, the system 1 is an example of a producing data output system of the present disclosure. The sewing machine 2 is an example of a sewing machine of the present disclosure. The cutting machine 3 is an example of a cutting machine of the present disclosure. The CPUs 41 and 71 are examples of a controller of the present disclosure. The mat 62 is an example of a mat of the present disclosure. The display 78 is an example of a display of the present disclosure. S6 is an example of an image acquisition process of the present disclosure. S7 is an example of a style conversion process of the present disclosure. S20 is an example of an output process of the present disclosure. S23 is an example of a selected producing type acquisition process of the present disclosure. S9 is an example of a producing candidate display process of the present disclosure. S14 process is an example of a size acquisition process of the present disclosure. S8 is an example of a converted image display process of the present disclosure. S19 is an example of a producing image display process of the present disclosure.

The system 1 of the above-described embodiment includes the CPUs 71 and 41 as a processor (controller), and outputs the producing data for producing the sheet-like medium. The CPU 71 performs the image acquisition process of acquiring the target image (S6). The CPU 41 performs the style conversion process of performing style conversion on the target image to generate the converted image of the selected style selected from the plurality of types of image styles including the first style and the second style (S7). The CPU 41 performs the output process of outputting the producing data based on the converted image (S20). The producing data is data for producing the medium by the selected producing type that is selected from one or more producing candidates associated with the selected style among the plurality of producing types including the first producing type and the second producing type. In the output process, in a case where the selected style is the first style, the producing candidate includes the first producing type and does not include the second producing type, and in a case where the selected style is the second style, the producing candidate includes the first producing type and the second producing type. In the system 1, the associated producing type differs depending on the type of style. The output process of the system 1 contributes to preventing the output of the producing data to be produced in the second producing type based on the converted image converted to the first style. That is, in the output process of the system 1, the producing data which is not suitable for the producing type is not output. Thus, the system 1 contributes to avoiding a situation in which the medium is produced by outputting producing data for producing in the second producing type from the converted image subjected to the style conversion based on the first style, and thereby the medium is not appropriately produced.

The system 1 of the modification includes the CPUs 71 and 41 as a processor (controller), and outputs producing data for producing the sheet-like medium. The CPU 71 performs the selected producing type acquisition process of acquiring the selected producing type that is selected from the plurality of producing types including the first producing type and the second producing type (S23). The CPU 71 performs the image acquisition process of acquiring the target image (S6). The CPU 71 performs the style conversion process of performing style conversion on the target image to generate the converted image of the selected style that is selected from one or more style candidates associated with the selected producing type among the plurality of types of image styles including the first style and the second style (S7). In the style conversion process, in a case where the selected producing type is the first producing type, the style candidate includes the first style and the second style, and in a case where the selected producing type is the second producing type, the style candidate includes the second style and does not include the first style. The CPU 41 performs the output process of outputting the producing data for producing the medium by the selected producing type based on the converted image (S20). In the system 1 of the modification, the associated style differs depending on the producing type. The style conversion process of the system 1 contributes to preventing style conversion of the target image to the first style in a case where the selected producing type is the second producing type. That is, in the style conversion process of the system 1, the target image is not subjected to style conversion to a style that is not suitable for the producing type. The style conversion process of the system 1 contributes to avoiding a situation in which the medium is produced by outputting the second producing data from the converted image subjected to style conversion based on the first style, and thereby the medium is not appropriately produced.

The plurality of producing types of the above-described embodiment include at least two of cutting, printing, and sewing as first producing type and second producing type. The cutting is performed by a cutting machine using cutting data for cutting a medium as producing data. The printing is performed by a printer using printing data for printing on a medium as producing data. The sewing is performed by a sewing machine using sewing data for forming stitches on a medium as producing data. The printing, the cutting, and the sewing are producing types in which the producing data is relatively commonly created based on the converted image acquired by performing style conversion on the target image. Since the plurality of producing types include at least two of the printing, the cutting, and the sewing as the first producing type and the second producing type, the system 1 generates various types of producing data based on the converted image and contributes to improvement of user convenience.

The system 1 includes the display 78. The CPU 71 performs the producing candidate display process of displaying producing candidates on the display 78 in a selectable manner (S9). The CPU 41 outputs, based on the converted image, producing data for producing the medium by the selected producing type that is selected from the producing candidates displayed on the display 78 (S20). The producing candidate display process of the system 1 contributes to allowing the user to easily select the selected producing type from one or more producing candidates.

The CPU 71 controls the display 78 to display the producing candidates in a selectable manner in the producing candidate display process (S9). In the producing candidate display process of the system 1, selectable producing candidates are displayed on the display and unselectable producing candidates are not displayed on the display, which contributes to allowing the user to easily select the selected producing type from one or more producing candidates.

In the producing candidate display process, in a case where the selected style is the first style, the CPU 71 displays the first image on the display 78 (S9). The first image indicates that the first producing data that is producing data of the first producing type can be output and the second producing data that is producing data of the second producing type cannot be output. In a case where the selected style is the second style, the CPU 71 displays the second image on the display 78 (S9). The second image indicates that each of the first producing data and the second producing data can be output. The producing candidate display process of the system 1 contributes to allowing the user to easily select the selected producing type by referring to the image displayed on the display 78.

The first image includes the first object for inputting the first instruction to output the first producing data, and does not include the second object for inputting the second instruction to output the second producing data. The second image includes the first object and the second object. When the first object displayed on the display is selected and the first instruction is input, the CPU 41 outputs the first producing data. When the second object displayed on the display is selected and the second instruction is input, the CPU 41 outputs the second producing data. The producing candidate display process of the system 1 contributes to selecting the selected producing type by a simple operation of selecting a desired object from the objects of the image displayed on the display 78.

The CPU 41 outputs the producing image based on the converted image and the plurality of types of parameters of which the initial values are set according to the selected style (S20). The output process of the system 1 contributes to outputting the producing data by using the parameters appropriately set according to the selected style. The output process contributes to reducing the time and effort of the user who adjusts the parameters in consideration of the selected style.

The CPU 71 performs the size acquisition process of acquiring a size corresponding to the producing region of the medium (S14). The initial values of the parameters are set according to the selected style and the size of the producing region. The output process of the system 1 contributes to outputting the producing data in consideration of the size corresponding to the producing region.

In a case where the selected producing type is sewing that uses sewing data for forming stitches on the medium as the producing data and that is performed by the sewing machine 2, the size corresponding to the producing region is the size of the embroidery frame 17 that is attached to the sewing machine 2 and that holds the medium. The output process of the system 1 contributes to outputting the sewing data in consideration of the size of the embroidery frame.

In a case where the selected producing type is cutting that uses cutting data for cutting the medium as the producing data and that is performed by the cutting machine 3, the size corresponding to the producing region is the size of the mat 62 that is used in the cutting and that holds the medium. The output process of the system 1 contributes to outputting the cutting data in consideration of the size of the mat 62.

The system 1 includes the CPU 71 and the display 78, and outputs the producing data for producing the sheet-like medium. The CPU 71 performs the converted image display process of performing style conversion on the target image to generate the converted image of the selected style selected from the plurality of types of image styles including the first style and the second style and displaying the converted image (S8). The CPU 71 performs the producing candidate display process of displaying one or more producing candidates associated with the selected style among the plurality of producing types including the first producing type and the second producing type (S9). In the producing candidate display process, in a case where the selected style is the first style, the producing candidate includes the first producing type and does not include the second producing type, and in a case where the selected style is the second style, the producing candidate includes the first producing type and the second producing type. The CPU 71 performs the producing image display process of displaying the producing image representing the producing data for producing the medium by the selected producing type. The selected producing type is selected from the producing candidates based on the converted image (S19). The producing candidate display process of the system 1 contributes to allowing the user to easily select the selected producing type from one or more producing candidates. That is, in the system 1, a producing type that is not suitable for the selected style is not selected. Thus, the producing candidate display process of the system 1 contributes to avoiding a situation in which the medium is produced by outputting producing data for producing in the second producing type from the converted image subjected to style conversion based on the first style, and therefore the medium is not appropriately produced.

While the present disclosure has been described in conjunction with various example structures outlined above and illustrated in the figures, various alternatives, modifications, variations, improvements, and/or substantial equivalents, whether known or that may be presently unforeseen, may become apparent to those having at least ordinary skill in the art. Accordingly, the example embodiments of the disclosure, as set forth above, are intended to be illustrative of the present disclosure, and not limiting the present disclosure. Various changes may be made without departing from the spirit and scope of the disclosure. Thus, the disclosure is intended to embrace all known or later developed alternatives, modifications, variations, improvements, and/or substantial equivalents. Some specific examples of potential alternatives, modifications, or variations in the described disclosure are provided below.

For example, the present disclosure may be implemented in various forms, and may be implemented in the form of, for example, a non-transitory computer-readable storage medium storing a display program, a display method performed by a controller of a terminal apparatus, and a producing data output method performed by a controller of a producing data output apparatus.

(A) The configuration of the system 1 may be changed as appropriate. The system 1 may or may not include a producing apparatus. The type and number of producing corresponding to producing data that is output by the system 1 may be changed as appropriate, and may be two types of producing apparatuses selected from the sewing, the cutting, and the printing, or may include other producing types such as drawing by a plotter. In this case, the table T also stores a plurality of types of parameters in a case where the producing data is drawing data. The sewing machine 2 may be an industrial sewing machine or a multi-needle sewing machine that includes a plurality of needle bars. In a case where the sewing machine 2 is a multi-needle sewing machine, the number of needle bars is not particularly limited. The sewing machine 2 may be a sewing machine that is not configured to perform embroidery sewing. In this case, the sewing data may be data for sewing a utility pattern. A plurality of producing types may be performed by one producing apparatus. For example, the cutting machine 3 may be configured to perform drawing in addition to the cutting, and the sewing machine 2 may be configured to perform cutting in addition to the sewing. The type of the printer 9 may be changed as appropriate, and may be an inkjet printer or a label printer.

The configuration of the apparatus 4 may be changed as appropriate, and may be, for example, a smartphone and so on. The display 78 may be any display configured to display an image, and may be, for example, an organic EL display, a plasma display, a plasma tube array display, or an electronic paper display using electrophoresis and so on. The input interface of the terminal apparatus 7 may be a switch, a joystick, and so on, instead of or in addition to the touch panel, the keyboard, and the mouse. In at least the sewing machine 2, the cutting machine 3, or the printer 9, the communication interface may be changed or omitted. For example, some or all of the sewing data, the cutting data, and the printing data may be transmitted and received by wire, or may be delivered via a storage medium. The terminal apparatus 7 may be any producing apparatus. The types of styles by which the system 1 performs style conversion may be changed as appropriate, and the number of types of styles may be two or more. In the above-described embodiment, the first style, the second style, the first producing type, and the second producing type may be appropriately changed as long as the producing candidate satisfies a condition that the producing candidate includes the first producing type and does not include the second producing type in a case where the selected style is the first style and that the producing candidate includes the first producing type and the second producing type in a case where the selected style is the second style. In the above modification, the first style, the second style, the first producing type, and the second producing type may be appropriately changed as long as the style candidate satisfies a condition that the style candidate includes the first style and the second style in a case where the selected producing type is the first producing type and that the style candidate includes the second style and does not include the first style in a case where the selected producing type is the second producing type. For example, the style T5 may be the first style, the style T1 may be the second style, the printing may be the first producing type, and the cutting may be the second producing type. In this case, the system 1 avoids a situation in which cutting data is output based on the converted image G5 of the style T5 in which the outline shape of the pattern is unclear.

(B) The program including instructions for performing the steps of FIGS. 2 and 14 may be stored in the memory of each apparatus by the time when the CPU 71 or 41 performs the corresponding program. Thus, the method of acquiring the program, the route of acquiring the program, and the device storing the program may be changed as appropriate. The program performed by each apparatus may be received from another apparatus via a cable or wireless communication and stored in a storage device such as a memory. The other apparatuses include, for example, a PC and a server connected via a network.

(C) The steps of the main process are not limited to the example in which the steps are performed by the CPU 71 or 41, and a part or all of the steps may be performed by another electronic device (for example, an ASIC). The steps of the main process may be performed in a distributed manner by a plurality of electronic devices (for example, a plurality of CPUs). That is, the controller (processor) of the system 1 may be a plurality of electronic devices. The order of the steps of the main process may be changed, and steps may be omitted or added as necessary. The following changes may be made to the main process as appropriate.

The process of selecting the selected style from the style candidates is not limited to the case of being performed in accordance with an instruction from the user, and for example, the CPU 71 or the CPU 41 may perform image processing on the target image and automatically select an optimal style. The process of selecting the selected producing type from the producing candidates is not limited to the case of being performed in accordance with an instruction of the user, and for example, the CPU 71 or the CPU 41 may automatically select optimum producing type from the producing candidates in consideration of the producing apparatus connected to the system 1. In this case, the system 1 may not include the display 78.

The medium may be in the form of any sheet, and may be a paper sheet or a plastic sheet, for example. The size corresponding to the producing region may be changed as appropriate. For example, in a case where the selected producing type is the sewing, the producing region may be a sewing region set inside the embroidery frame, and the size corresponding to the producing region may be represented by the length of two sides of a rectangular sewing region. In a case where the selected producing type is the cutting, the producing region is a cutting region set on the mat 62, and the size corresponding to the producing region may be represented by the length of two sides of a rectangular cutting region. In a case where the selected producing type is the printing or drawing, the size corresponding to the producing region may be represented by the length of two sides of a rectangular medium. The size corresponding to the producing region may be set according to the size of the target image or may be the size of an object in the converted image.

The apparatus 4 may be configured to perform style conversion on the target image without using a trained model. In this case, the apparatus 4 may perform style conversion by using an image filter. The apparatus 4 may switch whether to use the trained model depending on the selected style. The terminal apparatus 7 may store the table T, and the terminal apparatus 7 may perform a part or all of the processes performed by the apparatus 4, such as the style conversion process. A part or all of the main process may be performed by the producing apparatus.

In the producing candidate display process, the CPU 71 may control the display 78 to display producing candidates in a selectable manner, and may control the display 78 to display a producing type other than the producing candidates among the plurality of producing types in an unselectable manner (S9). In this case, the CPU 71 may display the producing candidates and the producing type other than the producing candidates in different modes. More specifically, in the producing candidate display process, in a case where the selected style is the first style, the CPU 71 may control the display 78 to display an image including a key object with blue color and a key object with red color. Here, the key object with blue color indicates that the first producing data which is producing data of the first producing type can be output, and the key object with red color indicates that the second producing data which is producing data of the second producing type cannot be output. Alternatively, the CPU 71 may control the display 78 to display an image including a key object surrounded by a solid line and a key object surrounded by a broken line. Here, the key object surrounded by a solid line indicates that the first producing data which is producing data of the first producing type can be output, and the key object surrounded by a broken line indicates that the second producing data which is producing data of the second producing type cannot be output. The method of receiving the selected producing type may be changed as appropriate. The CPU 71 may receive an input of the selected producing type by an ID of a producing type, instead of selection of a key object.

The types, number, and values of the parameters stored in the table T may be changed as appropriate, and some or all of the parameters may be set by the user. The correspondence between the style and the producing type stored in the table T may be changed as appropriate. For example, in the table T, the printing may be associated with the style T3. Step S15 may be omitted, that is, the CPU 71 may not set initial values according to the selected style. In this case, for example, the previous values may be input as the initial values, or the same initial values may be set regardless of the style. Steps from S12 to S14 may be omitted, that is, the CPU 71 may not acquire the size corresponding to the producing region. In this case, the CPU 71 may set a size corresponding to the producing region depending on the selected producing type, or may set the same size regardless of the selected producing type. The CPU 71 may omit at least S8, S9, or S19.

What is claimed is:

1. A producing data output system configured to output producing data for producing a sheet-like medium, the producing data output system comprising:
a controller configured to:
acquire a target image;
perform style conversion on the target image to generate a converted image of a selected style, the selected style being selected from a plurality of types of image styles including a first style and a second style; and
output producing data based on the converted image, the producing data being data for producing the medium by a selected producing type, the selected producing type being selected from one or more producing candidates associated with the selected style, the one or more producing candidates being among a plurality of producing types including a first producing type and a second producing type,
in a case where the selected style is the first style, the one or more producing candidates including the first producing type and not including the second producing type,
in a case where the selected style is the second style, the one or more producing candidates including the first producing type and the second producing type.

2. The producing data output system according to claim 1, wherein the plurality of producing types includes, as the first producing type and the second producing type, at least two of:
cutting performed by a cutting machine by using cutting data for cutting the medium as the producing data;
printing performed by a printer by using printing data for printing on the medium as the producing data; and
sewing performed by a sewing machine by using sewing data for forming stitches on the medium as the producing data.

3. The producing data output system according to claim 1, further comprising a display,
wherein the controller is configured to:
control the display to display the one or more producing candidates in a selectable manner; and
output, based on the converted image, the producing data for producing the medium by the selected producing type, the selected producing type being selected from the one or more producing candidates displayed on the display.

4. The producing data output system according to claim 3, wherein the controller is configured to:
control the display to display the one or more producing candidates in a selectable manner, without displaying the plurality of producing types other than the one or more producing candidates in the selectable manner.

5. The producing data output system according to claim 3, wherein the controller is configured to:
in a case where the selected style is the first style, control the display to display a first image indicating that first producing data can be output and that second producing data cannot be output, the first producing data being the producing data of the first producing type, the second producing data being the producing data of the second producing type; and
in a case where the selected style is the second style, control the display to display a second image indicating that the first producing data and the second producing data can be output.

6. The producing data output system according to claim 5, wherein the first image includes a first object and does not include a second object, the first object being an object for inputting a first instruction to output the first producing data, the second object being an object for inputting a second instruction to output the second producing data;
wherein the second image includes the first object and the second object; and
wherein the controller is configured to:
in response to receiving selection of the first object displayed on the display to input the first instruction, output the first producing data; and
in response to receiving selection of the second object displayed on the display to input the second instruction, output the second producing data.

7. The producing data output system according to claim 1, wherein the controller is configured to:
output the producing data based on the converted image and a plurality of types of parameters, initial values of the plurality of types of parameters being set in accordance with the selected style.

8. The producing data output system according to claim 7, wherein the controller is configured to:
acquire a size corresponding to a producing region of the medium; and
wherein the initial values of the plurality of types of parameters are set in accordance with the selected style and the size corresponding to the producing region.

9. The producing data output system according to claim 8, wherein, in a case where the selected producing type is sewing performed by a sewing machine by using sewing data for forming stitches on the medium as the producing data, the size corresponding to the producing region is a size of an embroidery frame that is attached to the sewing machine and that holds the medium.

10. The producing data output system according to claim 8, wherein, in a case where the selected producing type is cutting performed by a cutting machine by using cutting data for cutting the medium as the producing data, the size corresponding to the producing region is a size of a mat that is used in the cutting and that holds the medium.

11. The producing data output system according to claim 1, wherein the first style is such a style that the target image is converted to the converted image having unclear outlines;
wherein the second style is such a style that the target image is converted to the converted image having clearer outlines than the first style;
wherein the first producing type is printing and the second producing type is sewing or cutting, the printing being performed by a printer by using printing data for printing on the medium as the producing data, the sewing being performed by a sewing machine by using sewing data for forming stitches on the medium as the producing data, the cutting being performed by a cutting machine by using cutting data for cutting the medium as the producing data; and
wherein, in a case where the selected style is the first style, the printing data is output as the producing data, and neither the sewing data nor the cutting data is output as the producing data.

12. A producing data output system configured to output producing data for producing a sheet-like medium, the producing data output system comprising:
a controller configured to:
acquire a selected producing type, the selected producing type being selected from a plurality of producing types including a first producing type and second producing type;
acquire a target image;
perform style conversion on the target image to generate a converted image of a selected style, the selected style being selected from one or more style candidates associated with the selected producing type, the one or more style candidates being among a plurality of types of image styles including a first style and a second style,
in a case where the selected producing type is the first producing type, the one or more style candidates including the first style and the second style,
in a case where the selected producing type is the second producing type, the one or more style candidates including the second style and not including the first style; and
output producing data based on the converted image, the producing data being data for producing the medium by the selected producing type.

13. The producing data output system according to claim 12, wherein the plurality of producing types includes, as the first producing type and the second producing type, at least two of:
cutting performed by a cutting machine by using cutting data for cutting the medium as the producing data;
printing performed by a printer by using printing data for printing on the medium as the producing data; and
sewing performed by a sewing machine by using sewing data for forming stitches on the medium as the producing data.

14. The producing data output system according to claim 12, wherein the controller is configured to:
output the producing data based on the converted image and a plurality of types of parameters, initial values of the plurality of types of parameters being set in accordance with the selected style.

15. The producing data output system according to claim 14, wherein the controller is configured to:
acquire a size corresponding to a producing region of the medium; and
wherein the initial values of the plurality of types of parameters are set in accordance with the selected style and the size corresponding to the producing region.

16. The producing data output system according to claim 15, wherein, in a case where the selected producing type is sewing performed by a sewing machine by using sewing data for forming stitches on the medium as the producing data, the size corresponding to the producing region is a size of an embroidery frame that is attached to the sewing machine and that holds the medium.

17. The producing data output system according to claim 15, wherein, in a case where the selected producing type is cutting performed by a cutting machine by using cutting data for cutting the medium as the producing data, the size corresponding to the producing region is a size of a mat that is used in the cutting and that holds the medium.

18. A producing data output system configured to output producing data for producing a sheet-like medium, the producing data output system comprising:
a display; and
a controller configured to:
perform style conversion on a target image to generate a converted image of a selected style, the selected style being selected from a plurality of types of image styles including a first style and a second style;
display the converted image on the display;
display one or more producing candidates associated with the selected style, the one or more producing candidates being among a plurality of producing types including a first producing type and a second producing type,
in a case where the selected style is the first style, the one or more producing candidates including the first producing type and not including the second producing type,
in a case where the selected style is the second style, the one or more producing candidates including the first producing type and the second producing type; and
display a producing image based on the converted image, the producing image representing producing data for producing the medium by a selected producing type that is selected from the one or more producing candidates.
